(19) United States
(12) Patent Application Publication
(10) Pub. No.: US 2012/0196252 A1
(43) Pub. Date: Aug. 2, 2012

(54) Tailgating Scenario Safety Training Device And Methods

(76) Inventors: Matthew James Jensen, Jacksonville, FL (US); Kenneth Blair Rogich, Concord, NC (US); Kim Elizabeth Alexander, Clemson, SC (US); John Russell Wagner, Seneca, SC (US)

(21) Appl. No.: 13/364,284

(22) Filed: Feb. 1, 2012

Related U.S. Application Data
(60) Provisional application No. 61/438,745, filed on Feb. 2, 2011.

(51) Int. Cl. G09B 9/04

(52) U.S. Cl. 434/62

(57) ABSTRACT

Disclosed is a driver training device that can be utilized to simulate the back of a moving vehicle. The training device can be utilized in a driver training program to help students learn proper distancing and how to avoid dangerous tailgating practices. A device can include a driver training apparatus comprising a taillight assembly that includes brake lights and/or other features to simulate the back of a moving vehicle. A training device can simulate the back of one or two vehicles, and can be powered by attachment to a lead vehicle or alternatively to a movable track. In addition, a training device can be adjustable to simulate a variety of differently sized vehicles and can be easily broken down into component sections for simple storage and transport.

### REFERENCE TO RELATED APPLICATIONS

This patent application claims the benefit of U.S. Provisional Application No. 61/438,745 filed on Feb. 2, 2011, the disclosure of which is incorporated herein by reference in its entirety.

### BACKGROUND OF THE INVENTION

1. Field of the Invention

The present invention relates to a driver training device and methods by using the said training device for driving safety training. More particularly, the present invention relates to a driver training device that can be utilized to simulate the back of a moving vehicle, and methods of training drivers to learn proper distancing and how to avoid dangerous tailgating practices by using the said driver training device.

Traffic crashes continue to be one of the leading causes of death and injury. Worldwide, the number of people killed in traffic crashes each year is estimated at almost 1.2 million, and the number of injured is believed to be as high as 50 million. Injury due to road traffic crashes ranked as the 9^{th} leading cause of global disease burden in 1999, and is projected to be the 3^{rd} leading cause by 2020. The National Highway Traffic Safety Administration estimates U.S. traffic crash costs total nearly $231 billion, including the lifetime cost of fatal and non-fatal injuries, property damage, and lost market productivity. In 2010, the Centers for Disease Control and Prevention found the one-year cost of medical care and lost productivity associated with motor vehicle crash injuries exceeded $99 billion.

The cost in human lives of traffic crashes has improved somewhat in the last several decades due to safety legislation that required increased focus on vehicle and roadway design standards. For instance, statistics have shown that the use of seat belts and mandatory seat belt laws have saved thousands of lives that might have otherwise been lost in collisions. Since model year 1998, all new cars sold in the U.S. have been required to have airbags on both the driver and passenger sides. Statistics to date show that airbags reduce the risk of dying in a direct frontal crash by about 30%.

Road design and traffic control have also become common tools to decrease the number and severity of traffic crashes. Design elements include evaluation of traffic flow volume and patterns, speed limits, stop light timing and location, and curb and barrier design and location, among others. Improved road safety through road and traffic engineering have proven useful tools, particularly in areas of population growth and increased vehicle usage.

Engineering designs directed toward road and vehicle safety can only provide so much improvement in traffic injury and death statistics. Ultimately, the responsibility for safe travel on the roadways lies with the driver. Unfortunately, minimal focus has been given to the human element in automotive safety. Some initiatives have shown promise, however. For instance, many states in the U.S. now require mandatory driver education that is typically classroom based with some supplemental driving practice. In addition, variations of driver training programs are now available (though without any standardization) such as safe driving practices for particular age groups, advanced driver training, race driving training, commercial driver training, and so forth.

An increase in realistic driving practice would be of great benefit in developing improved driver training. A few tools exist for realistic driving simulation, though these are generally quite limited in scope and availability due to cost and technical requirements. In general, there are two different types of devices for driving simulations: electronic driving simulators, which utilize computer monitors with interactive data input (e.g., steering wheel, foot pedals, etc.) and vehicle attachment mechanisms. Electronic driving simulators can be a simple single computer monitor system or can be quite complex, including multiple viewing screens, a full vehicle cab and a motion base. Vehicle attachment mechanisms include devices such as the skid car described by Johansson, et al. in U.S. Pat. No. 4,700,798. The skid car includes a separate lifting frame that is carried by four castor wheels and is disposed under a car and propelled by the car. The frame is designed such that one or more of the car wheels can be raised relative to the ground to simulate skid conditions, for instance on a test track.

What is needed in the art is a mechanism that can be utilized to simulate other dangerous driving conditions, such as tailgating. For instance, a tailgating simulation device that can be relatively inexpensive to construct, can perform under a wide range of speeds, can be adjustable for use with a variety of control mechanisms to simulate a variety of different vehicle types, and can experience a collision without damage to the apparatus or the vehicle driven by the student, would be of great benefit.

2. Description of Related Art

Some related prior inventions are disclosed as prior art herein. More specifically, by way of example:

U.S. Pat. No. 5,927,986 disclosed driver training device for visual avoidance simulation.

U.S. Pat. No. 4,700,798 disclosed a skid car including a separate lifting frame that is carried by four castor wheels and is disposed under a car and propelled by the car. The frame is designed such that one or more of the car wheels can be raised relative to the ground to simulate skid conditions, for instance on a test track.

### SUMMARY

In an exemplary embodiment of the present invention, there is disclosed a driver training device that can be utilized to simulate the back of a moving vehicle, and methods of training drivers to learn proper distancing and how to avoid dangerous tailgating practices by using the said driver training device.

According to one embodiment, described is a driver training device that includes a driver training apparatus comprising one or more taillight assemblies, each taillight assembly including at least one brake light for simulating a brake light on a motor vehicle. The training device also includes a motive device attached to the driver training apparatus, the motive device enabling motion of the driver training apparatus along a track upon which a motor vehicle can be driven. For instance, the motive device can be a motor vehicle, and the driver training apparatus can be attached to the motor vehicle via a hitch on the back of the motor vehicle.

The driver training apparatus can include multiple features to simulate the back of a vehicle, for instance, the taillight assembly can include at least two brake lights, and the distance between the two brake lights can be adjustable. Moreover, the taillight assembly can include additional features, such as additional lights, bumpers, reflectors, and so forth.

A driver training apparatus can include multiple sections removably attachable to one another, so as to be assembled and disassembled, for instance for storage or relocation. In addition, an apparatus can be adjustable, for instance frame pieces of a device can be adjustable in length, to alter the overall size of the device.

Also disclosed is a method for training a driver of a motor vehicle by use of a driver training device as described herein. A method can include moving a driver training device around a test track and evaluating the performance of a vehicle following the driving training apparatus around the test track. Evaluation can include one or more of determination of distance maintained between the driver training apparatus and the following vehicle, determination of speed of the driver training apparatus and speed of the following vehicle, determination of acceleration and deceleration of the following vehicle, determination of the stopping time and distance of the following vehicle, and determination of collision forces between the driver training apparatus and the following vehicle.

A method can be carried out in conditions so as to better simulate real-world driving, for instance when the test track is wet or night driving when the method is carried out in the dark.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE FIGURES

A full and enabling disclosure of the subject matter, including the best mode thereof, directed to one of ordinary skill in the art, is set forth more particularly in the remainder of the specification. Other aspects, features, and advantages of the present invention will become more fully apparent from the following detailed description, the appended claim, and the accompanying drawings in which similar elements are given similar reference numerals.

FIG. 1 is a schematic diagram of one embodiment of a training apparatus as disclosed herein.

FIG. 2 illustrates one of the taillight assemblies of FIG. 1.

FIG. 3 is a wiring diagram as may be utilized with one embodiment of a training apparatus.

FIG. 4 illustrates one method of use of a training apparatus as described herein.

FIG. 5 graphically illustrates the headway distance (distance between the training device and the student vehicle) vs. time for a student driver during an assessment test.

### DETAILED DESCRIPTION OF REPRESENTATIVE EMBODIMENTS

Reference now will be made in detail to various embodiments of the disclosed subject matter, one or more examples of which are set forth below. Each example is provided by way of explanation, not limitation. In fact, it will be apparent to those skilled in the art that modifications and variations may be made in the present disclosure without departing from the scope or spirit of the subject matter. For instance, features illustrated or described as part of one embodiment may be used on another embodiment to yield a still further embodiment. Thus, it is intended that the present disclosure covers such modifications and variations as come within the scope of the appended claims and their equivalents.

In general, the present disclosure is directed to a training device that can be utilized to simulate the back of a moving vehicle. The training device can be utilized in a driver training program to help students learn proper distancing and how to avoid dangerous tailgating practices. A training device comprising a training apparatus and a motive device can simulate the back of one or more vehicles, and can be powered by attachment to a vehicle or alternatively to a movable track. In addition, a training device can be adjustable to simulate a variety of differently sized vehicles and can be easily broken down into component sections, for simple storage and transport.

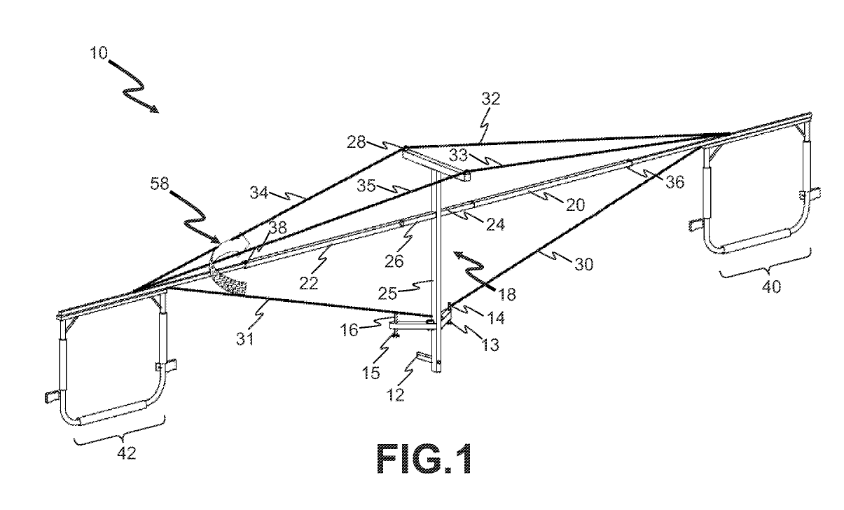

Referring to FIG. 1, one embodiment of a training apparatus 10 is schematically illustrated. In this particular embodiment, training apparatus 10 is designed to be mounted on the rear of a vehicle. In accord with this design, training apparatus 10 includes a connector 12 that can couple with a hitch on the rear of a vehicle. Any hitch as is generally known in the art can be utilized, for instance connector 12 can be utilized with a receiver-type hitch or a drawbar type hitch, as desired.

In conjunction with connector 12, the training apparatus 10 includes two secondary attachment points 14, 16 that can interact with the bumper of a vehicle onto which the apparatus 10 can be mounted. For instance, attachment points 14, 16 can include threaded tension rods 13, 15 that can be tightened against the bumper of a vehicle when the connector 12 is coupled to the hitch, e.g., when the tongue is coupled to the tow-ball of a receiver-type ball hitch. It should be understood, however, that secondary attachment points 14, 16, are not required in a vehicle mount-type apparatus, and in another embodiment, an apparatus can be mounted to a vehicle utilizing only a single attachment point at the hitch or any suitable alternative connection mechanism.

The preferred design of a connector will generally depend upon the motive device to which the training apparatus will be attached during use. For instance, in the illustrated embodiment of FIG. 1, the motive device can be a vehicle, e.g., a car or a truck. As such, the connector 12 is designed to attach to a hitch on a vehicle. Other vehicle attachment mechanisms can be utilized. For instance, a training apparatus can be designed to attach to the frame of a vehicle and extend from the side of the vehicle. In another embodiment, a training apparatus can be attached to or otherwise be immobilized within the bed of a truck and extend laterally from the side of the truck bed during motion.

In another embodiment, a training apparatus can be designed to attach to a moving track, for instance a chain drive or any other type of belt drive that can move a training apparatus along an indoor or outdoor test track. For instance, a track can include a vertical receiver onto which the base of a training apparatus can be firmly attached. In those embodiments in which a training apparatus is attached to a moving track, a training apparatus can be connected to the moving track at the base of the apparatus or at the top of the apparatus, for instance a training apparatus can hang down from a moving track in an indoor test track.

The primary frame structure of apparatus 10 includes vertical riser 18 and horizontal frame pieces 20, 22. In general, the frame sections 18, 20, 22 can all be formed of the same materials, but this is not a requirement of the devices. For instance, in order to minimize the weight of the apparatus, all or a portion of the frame pieces 18, 20, 22 can be formed of aluminum or some other relatively light weight material, for instance a light weight polymeric material. In order to reduce weight further, one or all of the frame sections 18, 20, 22 can be hollow. Frame pieces 18, 20, 22 can have any suitable cross sectional shape including, without limitation, circular, square, rectangular, or ovoid. In addition, frame pieces 18, 20, 22, can have a relatively small cross sectional diameter, for instance less than about 4 inches, so as to limit the weight of an apparatus and to minimize air resistance of an apparatus during use.

Frame pieces 18, 20, 22 can be formed of the same or different materials as one another. For example, vertical riser 18 can be formed of a heavier material, such as steel, which can help to maintain rigidity of an apparatus, while horizontal frame pieces 20, 22 can be formed of a lighter material, e.g., aluminum, to minimize weight of an apparatus.

Connector 12 and secondary attachment points 14, 16 can be formed as integral portions of vertical riser 18, or can be connectable thereto. In addition, vertical riser 18 can include connections 24, 26 for connection to horizontal frame pieces 20, 22. By way of example vertical riser 18 can be formed of boxed steel and can include connections 24, 26 that extend laterally from the vertical riser 18 when the apparatus 10 is mounted to a hitch on the back of a vehicle via connector 12. For instance, connections 24, 26 can be permanently extended from post 25 of vertical riser 18 or can be foldably attached thereto, such that when the apparatus 10 is disassembled, connections 24, 26 can fold in against post 18.

In one embodiment, connections 24, 26 can be formed of boxed steel with an inner dimension made to fit the outer dimension of horizontal frame pieces 20, 22 (or vice versa). Thus, connection 24 can slide into or over horizontal frame piece 20 and connection 26 can slide into or over horizontal frame piece 22 during assembly. The various pieces can be pinned or otherwise locked together following connection to one another.

At the top of vertical riser 18 is a cross piece 28 that extends laterally from post 25, as shown. In addition, cross piece 28 is rotated approximately 90° with respect to connections 24, 26. Thus, upon assembly of apparatus 10 and mounting of apparatus 10 to the rear of a vehicle, horizontal frame pieces 20, 22 can extend generally parallel to the ground and across the back of the mounting vehicle, and cross piece 28 can extend generally parallel to the ground and be aligned with the mounting vehicle.

Apparatus 10 also includes a series of tension cables 30, 31, 32, 33, 34, 35 that can help to maintain the structural rigidity of apparatus 10 during use. As can be seen, tension cables can extend from various locations on the vertical riser 18 to distal portions of the horizontal frame pieces 20, 22. Specifically, tension cables 32, 33, 34, and 35 can form a tie between each end of the cross piece 28 and distal points on horizontal frame pieces 20, 22, and tension cables 30, 31 can form a tie from the lower portion of vertical riser to distal points on horizontal frame pieces 20, 22. The vertical riser 18 and horizontal frame pieces 20, 22 can be formed to include suitable mounting points for the tension cables, such as rings, posts, or the like as are generally known in the art.

Apparatus 10 can be formed so as to be disassembled, for instance for storage and/or transport. In addition, an apparatus 10 can be formed so as to be adjustable in some or all dimensions. For instance and as previously mentioned, horizontal frame pieces 20, 22 can be releasably attachable to vertical riser 18. In addition, the frame pieces 18, 20, 22, can be adjustable in length. For instance, vertical riser 18 can include a telescoping segment (not shown) that can increase the distance from connector 12 to connections 24, 26. When this distance is increased, the taillight assemblies 40, 42 (discussed further below) will be higher. In one embodiment, the length of vertical riser 18 can be increased when taillight assemblies 40, 42 are intended to simulate the back of a vehicle with a high wheel base, such as a passenger truck or a semi truck. According to one embodiment, the distance between connector 12 and connections 24, 26 can be fixed or extendible such that the distance can be between about 36 inches and about 84 inches.

Similarly, horizontal frame pieces 20, 22 can be fixed or extendable. For instance the distance from vertical riser 18 to the center of either taillight assembly 40, 42 can generally be between about 120 inches and about 168 inches. In one embodiment, the distance from vertical riser 18 to the center of either taillight assembly 40, 42 can be generally equal to the minimum lane width of a typical highway, for instance about 12 feet.

At the distal end of each horizontal frame piece is a taillight assembly 40, 42. Taillight assemblies 40, 42 are designed to simulate the back of a vehicle during a simulation. In the embodiment of FIG. 1, taillight assemblies 40, 42 are generally identical to one another. However, it should be understood that this is not a requirement of a device and, in other embodiments, two taillight assemblies can be designed to simulate different sizes and/or types of vehicles. For instance, a first taillight assembly can be designed so as to simulate the taillights of a passenger car, and a second taillight assembly can be designed to simulate a larger vehicle, for instance a passenger truck or a semi truck, which can have a wider and/or higher wheel base.

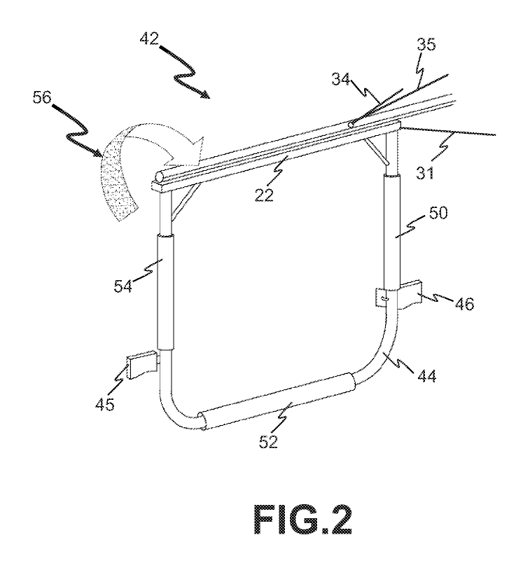

FIG. 2 illustrates taillight assembly 42 in greater detail. As can be seen, tension cables 31, 34, 35 are connected to mounting points (not shown) distributed on horizontal frame piece 22. Taillight assembly 42 includes a generally U-shaped bracket 44 and brake lights 45, 46, on either side of bracket 44.

The width of bracket 44 can be such that the brake lights 45, 46 are separated to simulate the brake lights of a vehicle. For example, brake lights 45, 46 can be between about 50 inches and about 55 inches apart, to simulate the two back brake lights on a typical mid-sized sedan. The distance between brake lights 45 and 46 can be varied to simulate larger or smaller vehicles. For instance, when considering a device that includes extendible portions, the width of bracket 44 can be increased by including telescoping joints on the horizontal segment of bracket 44 as well as on the horizontal frame piece 22.

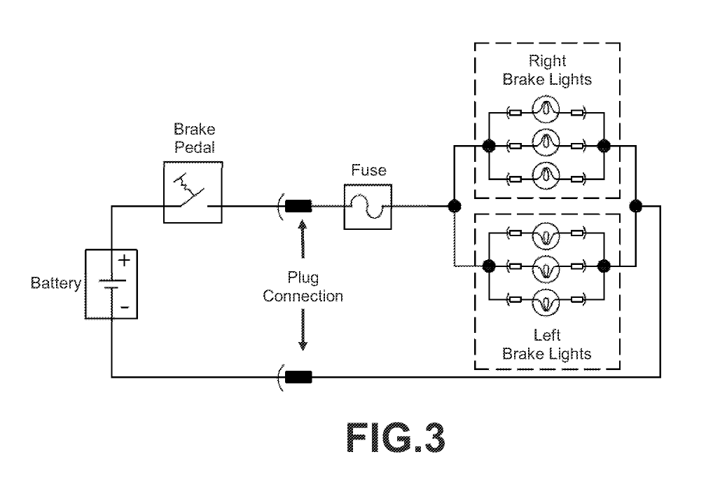

The electronics of training apparatus 10 can utilize standard methods and materials as are known to control the function of brake lights 45, 46. For instance, a standard trailer light kit, as is readily available in the retail market, can be utilized. For example, a light kit can include two stud mounted rectangular tail lights with wiring harness and four pole connector. The specific shape of the brake lights can be selected to better emulate a specific vehicle. For instance, oval or round lamps may be selected. Any suitable lights can be used in the taillight assembly, including either incandescent or LED lights. A representative wiring diagram is illustrated in FIG. 3 for an embodiment of a device that includes two taillight assemblies and basic truck brake subsystem wiring guide, each taillight assembly including three external lamps, as shown in FIG. 3.

Though illustrated with only two brake lights, a taillight assembly can include additional lights and/or features, as desired. For instance, a taillight assembly can include a third brake light above and centered between the other two lights, as is common on U.S. passenger cars. A taillight assembly can also include blinkers, back-up lights, reflectors, etc. as are common to vehicles. Additional elements may be added to a taillight assembly to simulate other elements of a vehicle. For instance, a cardboard or plastic cut-out of the rear of a vehicle can be attached to the taillight assembly, or a bumper can be added to the assembly. Such variations are well within the abilities of one of ordinary skill in the art.

Referring again to FIG. 2, bracket 44 has been fitted with padding 50, 52, and 54 as shown. Padding 50, 52, and 54 can prevent damage to both training apparatus 10 and the front of a vehicle upon collision between apparatus 10 and a vehicle following the device during a simulation. The addition of external padding to a bracket may or may not be necessary, depending upon the parameters of the system such as the materials used to form the taillight assembly, the speed at which a device is to be used, the nature of the training vehicle following the device, and the like.

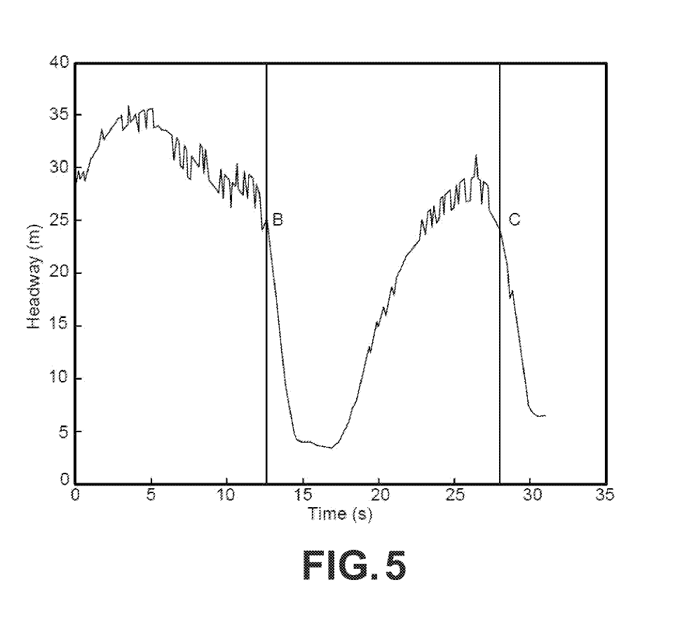

Apparatus 10 can include additional features to prevent damage to both apparatus 10 and a colliding vehicle during use. For instance, the apparatus 10 can be configured such that the base of bracket 44 will impact a colliding car at a predetermined level so as to prevent damage to the vehicle and to prevent deployment of the airbag of the vehicle. In one embodiment, the base of bracket 44 can be high enough so as to allow for little or no impact between the bracket 44 and the front end of the colliding vehicle. For example, the base of bracket 44 can be at a height off of the ground that, upon collision with a following vehicle, the base of bracket 44 will impact the hood of the following vehicle (see, e.g., FIG. 5).

Referring again to FIG. 1, to further avoid damage to either a training apparatus 10 or a following car upon collision, each horizontal frame piece 20, 22 can include a pivot 36, 38, respectively, thereon. Each pivot 36, 38 is designed such that upon collision between a following vehicle and a taillight assembly, the entire assembly can rotate away from the colliding vehicle. For instance, upon collision, taillight assembly 42 can pivot up and away from a colliding vehicle as illustrated by the directional arrow 56 on FIG. 2. The specific direction of rotation of a taillight assembly is not critical. For example, in another embodiment a taillight assembly can pivot back and away from the following vehicle in the direction of directional arrow 58 as shown on FIG. 1, in which case the entire taillight assembly can pivot toward the vertical riser 18. Additional padding can be added as necessary, for instance on secondary attachment points 14, 16, on tension cables 32, 34, and the like, to prevent damage to a vehicle carrying training apparatus 10.

In use, a training device can simulate the back of one or two vehicles. For instance, in the embodiment of FIG. 1, the apparatus 10 can simulate the back of two different vehicles, one at taillight assembly 40 and another at taillight assembly 42. In one embodiment, a device can include only a single taillight assembly and simulate only a single vehicle.

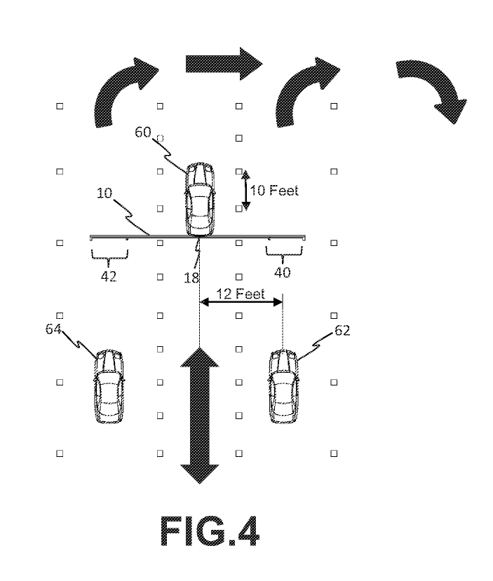

FIG. 4 illustrates one method of use for a device as illustrated in FIG. 1. As can be seen, a training apparatus 10 is attached to the back of a lead vehicle 60. Taillight assemblies 40, 42 are located at a distance from one another and from vertical riser 18 such that each taillight assembly can be centered in a traffic lane on either side of the traffic lane within which vehicle 60 travels. As vehicle 60 travels forward, turns corners, accelerates, decelerates, etc., vehicles 62, 64 can follow. The maximum speed attainable by training apparatus 10 can depend upon various factors such as the maximum longitudinal and lateral flex of the device, the device weight, and so forth. In general, however, a vehicle-mounted device can maintain structural rigidity under transient maneuvering up to about 50 miles per hour (mph) (80 kilometers per hour (kph)).

By following a training device during typical driving situations as well as atypical situations (e.g., sudden braking), students driving following vehicles 62, 64 can thereby attain realistic experience in following another vehicle. If, for example, a student driving vehicle 62 is following the lead vehicle 60 too closely, upon rapid deceleration by vehicle 60, vehicle 62 may collide with taillight assembly 40.

To better evaluate a simulation, a device can include monitoring equipment. For example, sensors, cameras, and other data collection devices can be deployed on an apparatus as well as on vehicles carrying an apparatus and vehicles following a device. By way of example, video cameras can record both the drivers' reactions and vehicles' motions during a stopping event and couple it with operating data such as vehicle speed, brake pedal position, collision forces, and stopping time. In this manner, quantitative and qualitative data can be examined following a simulation to determine whether the driver has sufficiently mastered the driving module concept.

The present disclosure may be better understood with reference to the Example, below.

### EXAMPLE

The development of a safe driver training curriculum was performed in conjunction with the design of the tailgate apparatus. The focus of the course was in-vehicle training for novice drivers with additional classroom instruction. The course totaled 75 minutes including a 15 minute introduction and demonstration, 30 minutes of in-vehicle driver training, and 30 minutes of classroom instruction. The course was designed for 16 students; however, larger groups may be accommodated with additional vehicles and instructors.

Nine learning objectives were divided into four categories including knowledge, skill, attitudinal, and experiential. Knowledge objectives focused on each participant's ability to recognize proper following distances while developing a strategy for determining proper following distances in a variety of driving situations and environmental conditions. Skill and knowledge objectives were constructed so that while the participant drivers were on the course, they applied what they learned in the classroom. The attitudinal objectives were used to ascertain the likelihood of the participants using their newly acquired knowledge and skills, and the experiential objectives defined what the course provided in the form of unique and practical driving events.

A device as illustrated in FIG. 1 was utilized with two participant-driven vehicles following the lead vehicle simultaneously, e.g. in FIG. 4. Participants experienced several scenarios using the tailgate apparatus including a generic tailgate situation with reduced following distance (less than two seconds), stop-and-go traffic patterns, and wet/icy roadway conditions. During the assessment run, participants were asked to select a comfortable following distance. In each scenario, the instructor-driver of the lead vehicle with the attached training device randomly brought the vehicle to an emergency stop, requiring the students in the following vehicles to react accordingly. During the stop-and-go scenario, the lead vehicle alternated between quick sudden stops, and moderate accelerations while never bringing the vehicle to a complete stop. In addition, a distraction was introduced into the student's vehicle cabin in the form of a ringing cell phone during the stop-and-go simulation. This distraction element was used to reduce the driver's focus on the lead vehicle, likely causing increased reaction times. The ringing cell phone was chosen for its realistic nature and ease of recognition.

The classroom portion of the curriculum supported the in-vehicle skill and decision-making practice. The instructor used several topical posters and video footage to demonstrate proper following distances behind lead vehicles, visual scanning methods and braking technique (non-skid). Additionally, several topics including adverse visibility and roadway conditions, appropriate following distances, the effect of reaction time on ‘pile-up,’ and large truck “no zones” were discussed.

Several assessment tools, including questionnaires, instructor evaluations, and driver-vehicle operational data, were utilized to evaluate the participants' completion of the course objectives. They were asked pre- and post-test knowledge questions. Experiential and skill assessment was performed by the in-vehicle driving instructors following the final (assessment run) scenario.

Twelve participants enrolled in a pilot curriculum including both the in-vehicle driving and classroom portions. Most participants (79%) were 15-17 years old. Participants #1-#4 were in one event with the same in-vehicle instructor, while participants #5-#12 were in a separate event each having the same in-vehicle instructor. All participants completed identical pre- and post-tests as well as a satisfaction survey at the end of the program.

Trained in-vehicle instructors administered the assessment of driving skills and documented the students' experiences. In addition, both lead and follow vehicles were instrumented with in-vehicle data recorders; the follow (student) vehicle included a Race-Keeper multi-camera video and data recording system. The Race-Keeper system gathered vehicle parameters from the On-Board Diagnostic port (OBD-II) including vehicle speed, Vₓ, and engine speed, N. External accelerometers measured the lateral, a_{y}, and longitudinal, aₓ, accelerations, and a GPS receiver were used to collect the vehicle's spatial position. Absolute vehicle position was not used; however, relative vehicle position from the lead vehicle allowed for derivation of the following distances was considered.

In addition to the data collection, the following vehicles were outfitted with small video cameras that allowed for video capture of vehicle views. Specifically, one camera was attached to each vehicle's windshield facing towards the front of the vehicle. The other camera was mounted to the dashboard facing toward the rear of the vehicle, capturing the driver and instructor.

Student performance was evaluated through an analysis of collected qualitative and quantitative data. A variety of vehicle signals were recorded and examined including:

tₕ—time between the rear bumper of the lead truck and the front bumper of the student driven vehicle

tₕₘₐₓ, tₕₘᵢₙ—maximum and minimum tₕ

xₕ—distance between the rear bumper of the lead truck and the front bumper of the student driven vehicle as measured using GPS data.

xₕₘₐₓ, xₕₘᵢₙ—maximum and minimum xₕ

v_{f}—velocity before braking

a_{decel}—the vehicle deceleration

tᵣ—reaction time of driver

tₛₜₒₚ—braking time to stop

x_{f}—distance traveled before braking)

xₛₜₒₚ—braking distance

In FIG. 5, the vehicle headway distance has been displayed versus time for a single student. Vertical lines labeled “B” and “C” indicate the beginning of the two sequential braking events. The braking event was initiated by the truck at t=12.0 seconds; the participant responded at t=12.5 seconds which represents a 0.5 second reaction time. The speed of the vehicles just before braking was vₓ=32.1 mph (51.7 kph) (truck) and vₓ=38.0 mph (61.2 kph) (students' vehicle). Similarly, the vehicle decelerations were a_{decel}=−7.6 ft/s² (−2.32 m/s², −0.24 g's) and −8.9 ft/s² (−2.65 m/s², 0.27 g's) respectively.

The data for all participants is compiled in Table 1. Two instrumented vehicles and the lead vehicle operated on a closed course during a two-day time period with two in-vehicle instructors and one tailgate apparatus instructor driver. Both objective (obj.) and subjective (subj.) evaluations were included in each student's overall average rating with each given equal weighting. In general, the subjective and objective scores for the students are similar with the average difference between scores equal to 11.4%. Note that subjects #1-#4 and #5-#12 were from different events, and therefore had a different in-vehicle instructor. This may explain the small variance, σ2, in subjective grading for students #5-#12 (σ2subject=21.4, σ2object=35.1) compared to students 1-4 (σ2subject=425, σ2object=63.8). The instructors used a standardized record sheet to evaluate the participants; however, instructors also used personal judgment in certain objective grading areas.

TABLE 1

| | Vehicle Headway | | | | | | | | | | | | | |
|---|---|---|---|---|---|---|---|---|---|---|---|---|---|---|
| | Max | | Min | | | | | | | | Hit | | | |
| Driver | tₕₘₐ | xₕₘₐₓ | tₕₘᵢₙ | xₕₘᵢₙ | tᵣ | V_{f} | x_{f} | a_{decel} | tₛₜₒₚ | xₛₜₒₚ | Cart* | Performance Rating | | |
| No. | (s) | (m) | (s) | (m) | (s) | (kph) | (m) | (m/s²) | (s) | (m) | (Y/N) | Subj. | Obj. | Avg. |
| 1 | 7.1 | 34.5 | 0.8 | 3.0 | 0.5 | 61.2 | 9.8 | −2.7 | 4.4 | 16.8 | N | 100 | 87 | 93.5 |
| 2 | 8.8 | 26.4 | 0.6 | 2.9 | 1.9 | 50.5 | 5.6 | −9.6 | 2.4 | 10.4 | N | 80 | 85 | 82.5 |
| 3 | 7.6 | 32.2 | 0.7 | 4.3 | 0.7 | 50.5 | 6.9 | −9.6 | 3.0 | 6.9 | N | 50 | 73.5 | 61.5 |
| 4 | 8.6 | 31.2 | 0.7 | 6.1 | 0.4 | 56.2 | 7.1 | −7.1 | 2.9 | 7.8 | N | 80 | 92.5 | 86.5 |
| 5 | 8.0 | 64.9 | 2.4 | 16.4 | 2.4 | 49.2 | 29.3 | −1.5 | 8.6 | 12.9 | N | 100 | 88.5 | 94.5 |
| 6 | 8.8 | 82.4 | 3.8 | 24.6 | 1.7 | 36.5 | 34.7 | −1.1 | 8.0 | 10.1 | N | 90 | 84.5 | 87.5 |
| 7 | 7.0 | 82.3 | 2.4 | 24.6 | 3.1 | 44.6 | 40.3 | −1.0 | 7.7 | 15.7 | N | 100 | 84.5 | 92.5 |
| 8 | 8.8 | 78.7 | 2.6 | 15.8 | 2.8 | 49.2 | 32.6 | −1.2 | 6.9 | 16.8 | N | 100 | 86.5 | 93.5 |
| 9 | 8.1 | 94.7 | 2.2 | 17.1 | 3.2 | 50.5 | 27.1 | −2.0 | 7.5 | 9.0 | N | 100 | 96.5 | 98.5 |
| 10 | 7.3 | 90.3 | 3.0 | 18.5 | 2.4 | 38.1 | 28.9 | −0.6 | 6.7 | 10.4 | N | 90 | 76.5 | 83.5 |
| 11 | 9.7 | 96.3 | 2.8 | 20.0 | 3.7 | 48.9 | 33.7 | −1.4 | 5.7 | 13.7 | N | 100 | 92.5 | 96.5 |
| 12 | 9.5 | 88.7 | 2.5 | 18.7 | 3.1 | 44.4 | 27.4 | −1.3 | 7.4 | 8.5 | N | 100 | 87.5 | 94.0 |

*Y—Yes, N—No

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A driver training device comprising:
a driver training apparatus comprising at least one taillight assembly including at least one brake light for simulating a brake light on a motor vehicle; and
a motive device attached to the said driver training apparatus, the motive device enabling motion of the driver training apparatus along a track upon which a motor vehicle can be driven.

2. The driver training apparatus according to claim 1, wherein the motive device is a motor vehicle, or a moving track including but not limited to a chain drive or any other type of belt drive that can move a training apparatus along an indoor or outdoor test track.

3. The driver training device of claim 2, wherein the driver training apparatus is attached to the motor vehicle via a hitch on the back of the motor vehicle.

4. The driver training device of claim 1, wherein the driver training apparatus further comprising of:
horizontal and vertical frame pieces that are fixed or adjustable in size, and the said frame pieces are made of the same or different materials selecting from steel, aluminum, light weight polymeric material or other light weight materials; and
at least one taillight assembly at one end or/and both ends of the horizontal frame pieces, and the said tailing assembly includes a bracket fixed or adjustable in size, and at least one brake light on either or/and both sides of the said bracket.

5. The driver training device of claim 4, wherein the taillight assembly including additional lights and/or one or more elements for simulating the back end of a vehicle.

6. The driver training device of claim 4, wherein the apparatus comprising two taillight assemblies attached to the motive device, and the said two taillight assemblies are the same or different.

7. The driver training device of claim 4, wherein the device comprises multiple sections removably attachable to one another.

8. The driver training device of claim 4, further comprising a pivot in mechanical communication with the taillight assembly.

9. The driver training device of claim 4, wherein further comprising of tension cables extend from various locations on the vertical frame pieces to distal portions of the horizontal frame pieces.

10. The driver training device of claim 4, wherein further comprising of monitoring equipments deployed on an apparatus as well as on vehicles carrying an apparatus, including sensors, cameras, and other data collection devices.

11. The driver training device of claim 1, wherein the driver training apparatus further comprising of:
horizontal and vertical frame pieces that are fixed or adjustable in size, and the said frame pieces are made of the same or different materials selecting from steel, aluminum, light weight polymeric material or other light weight materials;
tension cables extend from various locations on the vertical frame pieces to distal portions of the horizontal frame pieces;
one or two taillight assemblies at one or both ends of the horizontal frame pieces, and the said tailing assembly includes a bracket fixed or adjustable in size, and one or two brake lights on either or both sides of the said bracket; and
a pivot in mechanical communication with the taillight assembly;
The motive device is a motor vehicle to which the driver training apparatus is attached via a hitch on the back of the motor vehicle.

12. A driver training device comprising one or more aspects of the embodiments described herein, or variants thereof.

13. A method of training a driver of a motor vehicle comprising:
moving around a test track a driver training device comprising a driver training apparatus comprising at least one taillight assembly including at least one brake light for simulating a brake light on a motor vehicle, and a motive device attached to the said driver training apparatus, the motive device enabling motion of the driver training apparatus along a track upon which a motor vehicle can be driven; and the driver training device simulates the back of a vehicle;
evaluating the performance of a vehicle following the driving training apparatus around the test track, the evaluation including determination of distance or relative speed maintained between the driver training apparatus and the following vehicle.

14. The method according to claim 13, wherein the driver training apparatus comprises two taillight assemblies, the method further comprising evaluating the performance of two vehicles following the driver training apparatus, each of the two vehicles following a different taillight assembly of the driver training apparatus.

15. The method according to claim 13, the evaluation further comprising determination of speed of the driver training apparatus and speed of the following vehicle.

16. The method according to claim 13, the evaluation further comprising determination of acceleration and deceleration of the following vehicle.

17. The method according to claim 13, the evaluation further comprising determination of the stopping time and distance of the following vehicle.

18. The method according to claim 13, the evaluation further comprising determination of collision forces between the driver training apparatus and the following vehicle.

19. The method according to claim 13, wherein the test track is wet.

20. The method according to claim 13, wherein the method is carried out in the dark.

21. A method comprising one or more aspects of the embodiments described herein, or variants thereof.
